(19) United States
(12) Patent Application Publication
(10) Pub. No.: US 2017/0030350 A1
(43) Pub. Date: Feb. 2, 2017

(54) Poppet Valve Assembly, System, and Apparatus for Use in High Speed Compressor Applications

(71) Applicant: Compressor Engineering Corporation, Houston, TX (US)

(72) Inventors: Justin K. Russell, Needville, TX (US); Richard K. Hotze, Houston, TX (US)

(73) Assignee: Compressor Engineering Corporation, Houston, TX (US)

(21) Appl. No.: 15/291,850

(22) Filed: Oct. 12, 2016

Related U.S. Application Data
(63) Continuation of application No. 13/428,973, filed on Mar. 23, 2012, now abandoned.

(51) Int. Cl. F04B 53/10; F16K 15/02

(52) U.S. Cl. CPC F04B 53/108; F16K 15/025

(57) ABSTRACT

A miniature poppet valve assembly for a high-speed compressor, the miniature poppet valve assembly includes a plurality of miniature poppets, each characterized by a stem and a head with a maximum head diameter of no more than 0.9 inches; a cage having a plurality of counter bores disposed therein, each counter bore disposed for receipt of a poppet; and a seat plate overlying the cage, the seat plate including a plurality of through bores axially aligned with the counter bores of the cage. Each counter bore includes a chamfered edge against which the head of the poppet seats, thereby forming a seal. The chamfered edged is provided with a chamfer angle of approximately 30 degrees. In one embodiment, poppet heads have a convex head surface and are shaped so that the tangent angle at the point of contact between the edge and the head is approximately 30 degrees.

### CROSS-REFERENCE TO RELATED APPLICATION

This application is a continuation of U.S. application Ser. No. 13/428,973, filed Mar. 23, 2012, the disclosures of which is incorporated herein by reference in its entirety.

### BACKGROUND OF THE INVENTION

Field of the Invention

The present invention relates to high-speed compressors, and more particularly, to control of gas flow in high-speed compressors utilizing a poppet valve assembly, and most particularly to the design of poppet valves to enhance flow rates through a poppet valve assembly.

Description of the Prior Art

Gas valve assemblies for conventional compressors, namely those operating at between approximately 200 rpm and approximately 600 rpm, often include poppets that have a head diameter ranging from 1 inch to approximately 1 and ⅛ inches. Typically, such systems utilize approximately two to 40 poppets with heads in this size range to control fluid flow within these compressors. The size of such conventional poppets in the valve assemblies of these conventional compressors does not allow for precise control of fluid flow, because a limited number of such conventional poppets may be included within the conventional valve assembly.

More recently, poppet valve assemblies have been proposed that utilize miniature poppets. The head of each miniature poppet has a maximum diameter that is less than approximately one inch and forms a sealing surface that is disposed to engage the edge of a bore in a seat plate so as to form a metal to metal seal between the seat plate and the head. The edge is provided with a 45 degree chamfer to enhance the metal to metal seal. However, it has been found that miniature poppet assemblies with a 45 degree chamfer on the edge of the seat plate bore does not permit sufficient effective flow area of the poppet and thus inhibits flow through the miniature poppet valve assembly, resulting in increased horsepower consumption due to valving.

While these miniature poppet valve assemblies have permitted a more precise gas control in certain high-speed compressor applications, particularly those operating in the 600-1500 rpm range or higher, they do not fully maximize flow past the poppet valvehead. There is a need in the miniature poppet valve assemblies to optimize flow past the poppet valvehead, thereby decreasing horsepower consumption due to valving over prior art systems.

### BRIEF SUMMARY OF THE INVENTION

The present disclosure relates generally to a miniature poppet valve assembly which may be utilized with high-speed compressor applications. Design of the poppet valve head and seat plate are selected to optimize fluid flow through the valve assembly.

A miniature poppet valve assembly includes a plurality of poppets, each poppet having a stem and a head. The head of each poppet has a maximum diameter that is less than one inch. The stem of each poppet is disposed in one of a plurality of counter bores formed in a valve cage. The poppet valve assembly also includes a seat plate overlying the cage, the seat plate including a plurality of through bores axially aligned with the plurality of counter bores of the cage. Each of the plurality of through bores is sized to have a smaller diameter than the maximum diameter of the head. Each head of each miniature poppet has an upper surface, a portion of which adjacent the periphery of the head and forms a sealing or abutment surface that is disposed to engage the edge of a respective through bore in a seat plate so as to form a seal between the seat plate and the head. The edge is provided with a 30 degree chamfer to enhance the seal.

In other embodiments, the edge may be provided with a chamfer that ranges from 20 degrees to 35 degrees.

In other embodiments, the abutment surface has a convex shape that is selected so that the tangent at the point of contact matches the chamber angle of the through bore edge. Therefore, if the edge is provided with a 30 degree chamber, the abutment surface is shaped so that tangent of the surface at the point of contact, i.e., adjacent the edge of the abutment surface, is 30 degrees with the centerline of the poppet.

### BRIEF DESCRIPTION OF THE DRAWINGS

Aspects of the present disclosure are best understood from the following detailed description when read with the accompanying figures. It is emphasized that, in accordance with the standard practice in the industry, various features are not drawn to scale.

FIG. 1 illustrates a partial cross-sectional view of an exemplary miniature poppet valve assembly of the invention, with a poppet illustrated in an open position.

FIG. 2 illustrates a top view of an exemplary miniature poppet valve assembly of the invention.

FIG. 3 illustrates a partial cross-sectional view of an exemplary miniature poppet valve assembly of the invention, with a poppet illustrated in a closed position.

FIG. 4 is a chart illustrating difference between effective flow area of a prior art miniature poppet valve assembly and the miniature poppet valve assembly of the invention.

### DETAILED DESCRIPTION

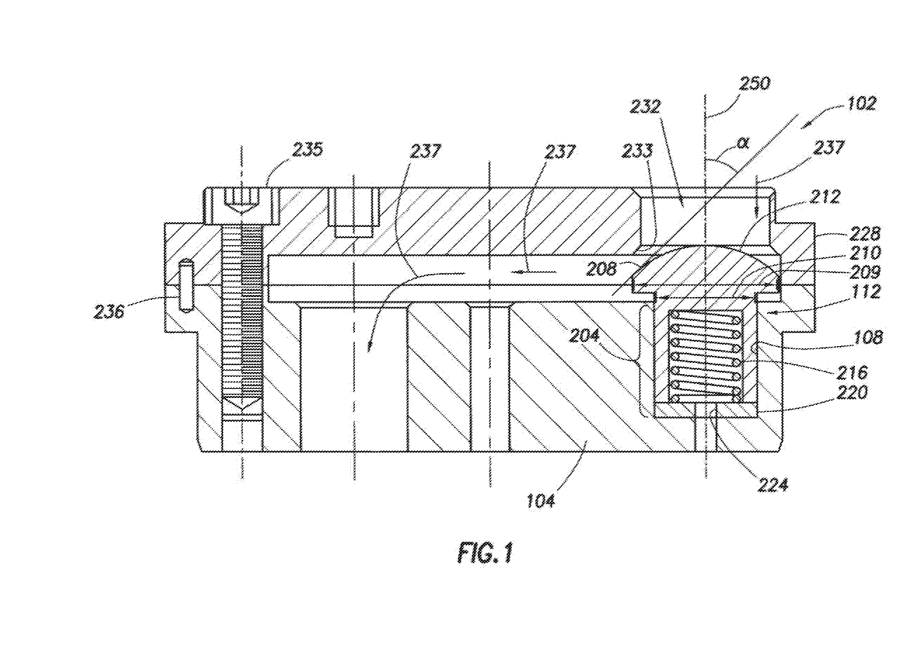

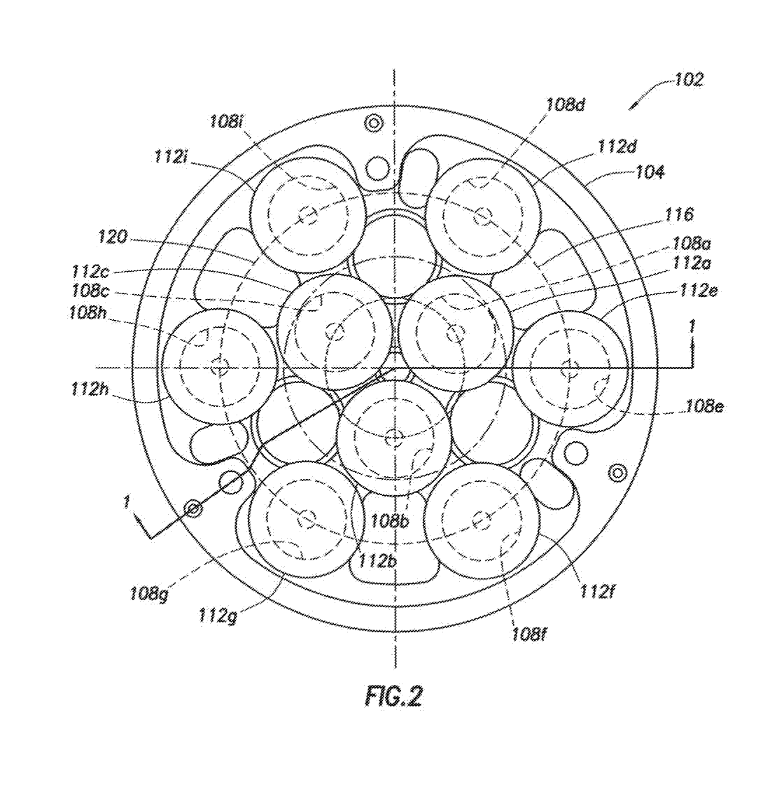

Referring now to FIGS. 1 and 2, respective partial cross-sectional and top views of a miniature poppet valve assembly 102 is shown. The miniature poppet valve assembly 102 includes a cage, stop plate or guard 104 in which a plurality of counter bores 108 are disposed. A plurality of miniature poppets 112 are carried by the cage 104, wherein each of the plurality of poppets 112 seats in a respective one of the plurality of counter bores 108 provided in the cage 104. Each poppet 112 includes a stem 204 and a head 208. The head 208 includes a sealing surface 212. A lift spacer 220 may be provided in counter bore 108.

Head 208 is characterized with a maximum outer diameter 209. Likewise, stem 204 is characterized with a maximum diameter 210. In certain embodiments, the head 208 has a maximum outer diameter 209 that is approximately 0.7 inches, and the stem 204 has a maximum diameter 210 that is approximately 0.44 inches. In certain embodiments, the maximum outer diameter 209 of the head 208 is less than 0.75 inches, and the maximum outer diameter 210 of the stem 204 is less than 0.5 inches. In yet another embodiment, the maximum outer diameter 209 of the head 208 is less than 0.9 inches.

In certain embodiments, the plurality of poppets in assembly 102 are substantially similar to one another. Of course, those skilled in the art will appreciate that in other embodiments, the poppets 112 may vary as described with respect to embodiments of the present disclosure.

As stated above, the stem 204 of poppet 112 is disposed in a counter bore 108. Preferably, the stem 204 is hollow and is adapted to house a guide spring 216. The spring 216 is disposed to urge the poppet 112 toward a seat plate 228 overlying the cage 104, and thereby place the poppet 112 in a closed position.

The seat plate 228 includes a plurality of through bores 232, each axially aligned with a counter bore 108. The through bore 232 is sized to have a smaller diameter than the maximum diameter 209 of the head 208. An edge 233 of the through bore 232 that interfaces with the sealing surface 212 is disposed to form a seat for receipt of head 208, preferably forming a seal between the seat plate 228 and the head 208.

In certain preferred embodiments, edge 233 has a 30 degree chamfer angle relative to the centerline 250 of through bore 232. In other preferred embodiments, edge 233 may have a chamfer angle that ranges between 20 degrees and 35 degrees.

In certain embodiments, sealing surface 212 is convex about centerline 250 with the shape of the sealing surface 212 selected so that the point on sealing surface 212 that engages edge 233 has a tangent line that forms an angle with centerline 250 that is the same as the chamber angle of edge 233. In other words, the tangent at the point of contact of sealing surface 112 preferably forms a right angle with the surface of the chambered edge 233.

In this regard, while angles between 20-35 degrees are contemplated, it has been found that for miniature poppets having a convex head, i.e., poppets less than 1 inch in head outer diameter, a desired angle for the tangent at the point of contact with a 30 degree chamfer is a 30 degree tangent angle.

In certain embodiments, to the extent head 208 is convex in shape, the radius of the head is selected to correspond to the desired tangent angle at the point of contact of the head with the edge 233. In certain embodiments, the radius of the head 208 is 0.688 inches.

In another embodiment, a flat shoulder 248 may be provided on sealing surface 212 to engage the flat surface of edge 233.

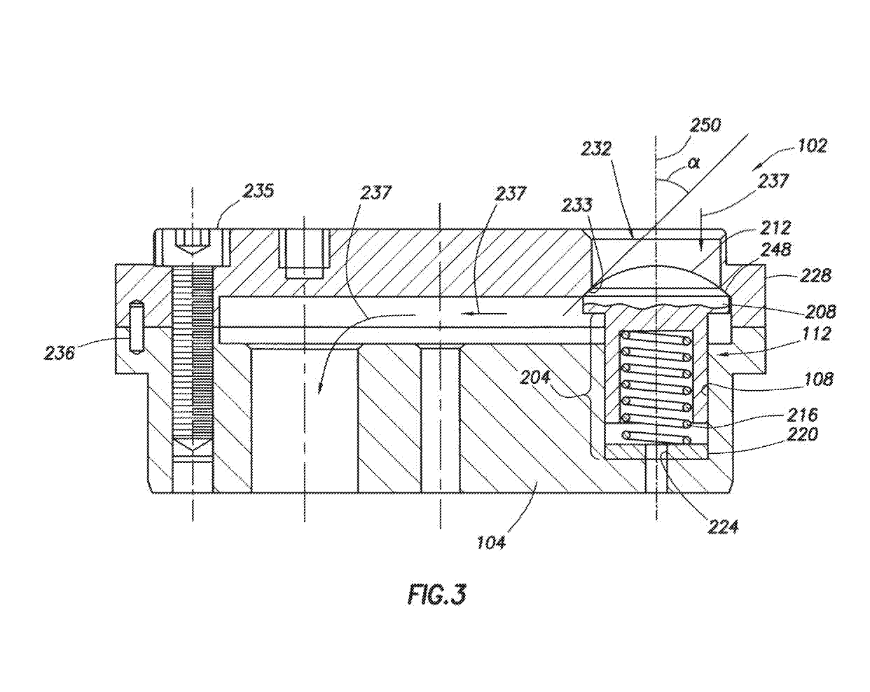

FIG. 3 illustrates miniature poppet valve assembly 102 in a closed position. In this embodiment, shoulder 248 engages edge 233.

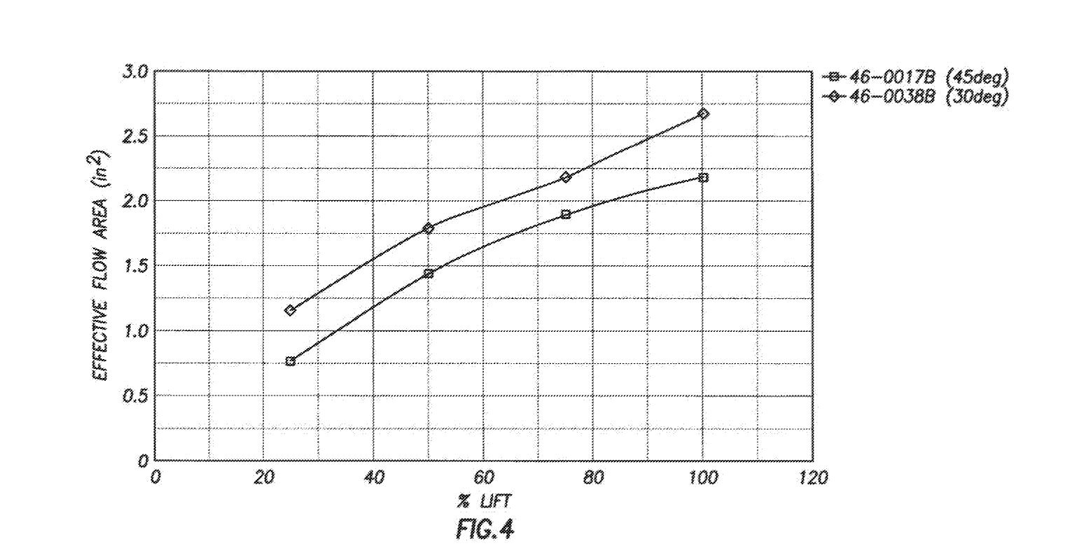

Those of ordinary skill in the art will appreciate that one parameter utilized to measure the efficiency of a valve is effective flow area. As shown in FIG. 4, by altering the chamfer angle from the 45 degree angle of the prior art to the 30 degree angle of the invention results in a ten percent improvement in effective flow area. With a larger effective flow area, pressure drop across the valve is minimized and thus, horsepower loss is minimized. In other words, the prior art miniature poppet valves with a 45 degree chamber angle result in a greater horsepower loss due to the valve relative to the 30 degree chamfer angle of the invention.

In any event, the cage 104 and the seat plate 228, when joined together, form a flow channel 237 that extends from the through bore 232 through the poppet valve assembly 102. The cage 104 and lift spacer 220 provide a versatile poppet valve assembly 102 that enables multiple flow area configurations, simplified assembly and manufacturing, and enhanced flow characteristics.

As specified above, the poppets 112 are smaller than conventional poppets. Conventional poppets have heads with outer diameters that ranges from approximately 1 inch to approximately 1 and ⅛ inches. In contrast, the head 208 of each of the poppets 112 of the invention has a maximum diameter 209 that is preferably approximately 0.7 inches, although this dimension may range in embodiments from approximately 0.5 inches to 0.9 inches.

In high-speed compressor applications, precise control of fluid flow is important. Part of this control is the ability to maximize fluid flow as desired. The poppet valve assembly 102 may be used in high-speed compressor applications to more precisely control fluid flow in a high speed compressor, while at the same time providing the ability to maximize fluid flow through the poppet valve assembly 102. In an embodiment, the high-speed compressor application may require operation at a speed that is between approximately 600 rpm and approximately 1500 rpm. In contrast, conventional compressors, using conventional poppet valve assemblies, are limited to operating at a much slower relative speed. For example, a conventional compressor using conventional poppet assemblies might be limited to operating at a speed that is between approximately 200 rpm and approximately 600 rpm.

Furthermore, because the poppets 112 include heads 208 that have a diameter that is larger than the diameter of the respective through bores 232, the sealing surface 212 and flow window of the poppets 112 extend beyond the maximum diameter 210 of the stem 204. One benefit of the foregoing is that it allows for use of a larger through bore 232 while maintaining a relatively small guiding body. Moreover, it facilitates the ability to manufacture a poppet 112 and valve plate 104 where the angle between the poppet seat, i.e., the chamfered edge of the through bore, and the tangent angle a of the sealing surface at the point of contact is in the range from 20-35 degrees, and preferably 30 degrees.

The poppets 112 of the invention may be used with lift spacers 220 as is known in the prior art.

Referring to FIG. 2, a top view of the poppet valve assembly 102 in accordance with an embodiment of the present disclosure is shown. In one preferred embodiment, cage 104 may be substantially circular in shape although the shape of cage 104 is not a limitation of the invention and those skilled in the art will understand that cage 104 can be of any desirable shape.

A plurality of miniature poppets 112a-112i are shown. By utilizing unconventionally small diameter poppets, a greater surface area of cage 104 can be covered by poppets 112, thereby permitting the same volume of gas to pass therethrough as compared to more conventional poppet valve assemblies, but in a more controllable manner.

The poppet 112 is fabricated from a high performance engineering thermoplastic. However, in other embodiments, the poppet valve assembly 102 may be fabricated from other materials, including without limitation, hardened steel, other metals or metal alloys.

Although only a few exemplary embodiments of this invention have been described in detail above, those skilled in the art will readily appreciate that many modifications are possible in the exemplary embodiments without materially departing from the novel teachings and advantages of this disclosure.

What is claimed:

1. A miniature poppet formed of thermoplastic for use in a high speed compressor, said poppet comprising:
an elongated stem having a first end and a second end and symmetrically defined about an elongated axis passing through the first end and the second end, the elongated stem having a spring seat formed therein and extending from the first end; and
a circular head mounted on the second end of the stem and symmetrically defined about the elongated axis, the circular head characterized by an outer diameter and an outer periphery and having a bottom surface and a convex top surface with an edge formed at the periphery of the circular head, wherein the bottom surface abuts the second end of the stem, wherein a portion of the top surface adjacent the edge forms an abutment surface characterized by a tangent that forms an angle of approximately 30 degrees with the elongated axis adapted to engage at a right angle a chamfer surface with an angle of approximately 30 degrees, wherein the outer diameter of the head is no more than 0.9 inches, wherein the edge is a substantially flat surface extending between the top surface and the bottom surface, wherein the abutment surface is a flat shoulder, wherein the spring seat is a bore coaxially formed along the elongated axis, wherein the outer diameter of the head is approximately 0.74 inches.

2. A poppet valve assembly comprising:
a cage, said cage including a plurality of counter bores disposed therein;
a plurality of miniature poppets formed of thermoplastic, each poppet comprising:
an elongated stem having a first end and a second end and symmetrically defined about an elongated axis passing through the first end and the second end, the elongated stem having a spring seat formed therein and extending from the first end; and
a circular head mounted on the second end of the stem and symmetrically defined about the elongated axis, the circular head characterized by an outer diameter and an outer periphery and having a bottom surface and a top surface with an edge formed at the periphery of the circular head, wherein the bottom surface abuts the second end of the stem, wherein a portion of the top surface adjacent the edge forms an abutment surface characterized by a tangent that forms an angle of approximately 30 degrees with the elongated axis, wherein the outer diameter of the head is no more than 0.75 inches,
wherein the stem is disposed in a corresponding one of the said plurality of counter bores, wherein the outer surface of the head is convex, wherein the abutment surface is a flat shoulder;
a seat plate overlying said cage, said seat plate including a plurality of through bores axially aligned with the plurality of counter bores of the cage, wherein each of the plurality of through bores is sized to have a smaller diameter than the maximum diameter of the head, wherein an edge of each of a plurality of through bores includes a chamfer characterized by a chamfer angle is approximately 30 degrees, wherein the seat plate is removably coupled to the cage;
a lift spacer disposed in a plurality of counter bores, wherein said lift spacer includes an aperture there through; and
a spring disposed in the partially hollow stem of each of the plurality of poppets so as to seat in the corresponding one of the plurality of counter bores.

3. A compressor system, the compressor system comprising:
a compressor operable at speeds of between 900 rpm and 1500 rpm, said compressor further comprising a poppet valve assembly comprising:
a cage, said cage including a plurality of counter bores disposed therein;
a plurality of miniature poppets, each poppet comprising:
an elongated stem having a first end and a second end and symmetrically defined about an elongated axis passing through the first end and the second end, the elongated stem having a spring seat formed therein and extending from the first end; and
a circular head mounted on the second end of the stem and symmetrically defined about the elongated axis, the circular head characterized by an outer diameter and an outer periphery and having a bottom surface and a top surface with an edge formed at the periphery of the circular head, wherein the bottom surface abuts the second end of the stem, wherein a portion of the top surface adjacent the edge forms an abutment surface characterized by a tangent that forms an angle of approximately 30 degrees with the elongated axis, wherein the outer diameter of the head is no more than 0.74 inches,
wherein the stem is disposed in a corresponding one of the said plurality of counter bores, wherein the outer surface of the head is convex, wherein the abutment surface is a flat shoulder;
a seat plate overlying said cage, said seat plate including a plurality of through bores axially aligned with the plurality of counter bores of the cage, wherein each of the plurality of through bores is sized to have a smaller diameter than the maximum diameter of the head, wherein an edge of each of a plurality of through bores includes a chamfer characterized by a chamfer angle of approximately 30 degrees, wherein the seat plate is removably coupled to the cage, wherein a combined surface area of the plurality of poppets is at least approximately 50% of a surface area of the cage;
a lift spacer disposed in a plurality of counter bores, wherein said lift spacer includes an aperture therethrough; and
a spring disposed in the partially hollow stem of each of the plurality of poppets so as to seat in the corresponding one of the plurality of counter bores.
